(19) United States
(12) Patent Application Publication
(10) Pub. No.: US 2011/0079670 A1
(43) Pub. Date: Apr. 7, 2011

(54) FAN-SHAPED GRATER FOR FOODSTUFFS

(75) Inventors: Najine Ameli, Munster (DE); Paul Budde, Munster (DE)

(73) Assignee: EMSA GMBH, Emsdetten (DE)

(21) Appl. No.: 12/997,329

(22) PCT Filed: Jun. 11, 2009
(86) PCT No.: PCT/EP09/57240

§ 371 Date: Dec. 15, 2010

(30) Foreign Application Priority Data
Jun. 12, 2008 (DE) 10 2008 027 918.8

(51) Int. Cl. A47J 43/25

(52) U.S. Cl. 241/95

(57) ABSTRACT

A fan-shaped grater (100) for foodstuffs comprises at least one base element (10) and at least one grater module (20, 30, 40). The base element (10) and grater module (20, 30, 40) therein are each curved, angled or cropped and run out into a head region (12, 22, 32, 42). A common pivot axis (1) runs through the head region (12, 22, 32, 42). By fanning out the grater modules (20, 30, 40) with respect to the base element (10), a parabola-shaped configuration is formed so that the fan-shaped grater (100) can stand independently and the grating surface (43) is positioned at a slant to the vertical pivot axis (1).

The invention relates to a fan-shaped grater for foodstuffs, having at least one basic element and at least one grater module, wherein the basic element and the grater module are in each case curved, angled or bent and end in a head region.

It is known to use hand graters for comminuting foodstuffs. These have a usually metallic grating surface having a plurality of openings at which protruding cutting edges are formed. When the article to be cut is guided along the grating surface, parts thereof are detached by the cutting edges and discharged through the openings. Conventional household graters usually have a gripping element and at the opposite end a foot element, in particular an elastomeric foot element, which provides a degree of slip-resistance with respect to the underlying surface when the grater is pressed against the support by way of its lower edge.

However, a disadvantage with known graters is that, in order to work in comfort, the grating surface element usually has to be kept at an angle of less than 90° with respect to the support plane. However, if a conventional household grater is held at an angle, transverse forces parallel to the underlying surface occur when working with said grater and lead to slippage of the grater. As a result, the work has to be interrupted repeatedly in order to reposition the grater in the working region on the support. A further disadvantage is that, depending on how coarse or fine the degree of comminution is intended to be, different graters are required and have to be stored and retrieved individually.

The object of the invention is to specify a grater for foodstuffs which makes it possible to work ergonomically and can be stored in a space-saving manner.

This object is achieved by a fan-shaped grater for foodstuffs having the features of claim 1.

Within the meaning of the invention, the term “parabolic” also includes U-shaped or V-shaped configurations and is understood to mean a configuration, as seen in at least one side view or in at least one cross section, having two elongate outer regions which carry the actual grating surface elements and the head pieces which project inwardly therefrom, i.e. are curved, angled or bent, and which are connected together via a pivot axis.

The term “grater” is also understood to mean, irrespective of the degree of comminution, planar utensils having cutting edges, that is to say both fine graters, e.g. for hard cheese, and also those having coarse cutter separations, e.g. for cucumber slices. Also intended to be included are those structures which are partially porous but have no cutting edges, i.e. sieve-like structures.

For storage purposes, the basic element and the grater module lie against one another in a shell-like manner; for example, the basic element lies on the outside and the grater module on the inside. As a result, only a very small amount of space is required.

In fan-shaped graters according to the invention having a plurality of grater modules, it is advantageous to arrange the basic element on the outside so that it can be gripped comfortably from the outside even when individual grater modules are still resting in the unused state on the inside.

In the case of a fan-shaped grater having only one grater module, the reverse arrangement is also possible, i.e. with the grater module on the outside and the basic element on the inside.

When at least one grater module then is pivoted out from behind the basic element, the parabolic configuration is achieved. In this case, the central axes of the basic element and the grater module do not necessarily have to lie on one diameter line. It is likewise possible for an angle of less than 180° to be included between them, with working in comfort still being possible.

Since the basic element is spread apart from the grater module in the fanned-out used state, a pressure can be applied from above, as a result of which the basic element and the grater module are simultaneously pressed against the support with their lower edges. The inclination of the grating surface on the grater module is defined according to the invention by the configuration and remains constant throughout the work. For example, it is 60°-75° with respect to the underlying surface or 15°-30° with respect to a vertical pivot axis.

In particular, undesired buckling is avoided by the parabolic configuration, even when considerable pressure is applied with the article to be cut. The user can concentrate fully on his work without continuously having to pay attention to the position of the grater. In addition, it is possible to place the fan-shaped grater over a vessel such that it spans the edges of the vessel and the cut article can be collected directly therein.

After use, the grater module can easily be cleaned, even under running hot water, for which purpose the user then only needs to grip the fan-shaped grater at the gripping piece and can clean the grater module spread apart therefrom without having to hold on to the grater module itself.

Preferably, the basic element has an inner wall and an outer wall spaced apart therefrom. Between these there is formed an accommodating space, which may even be closed off at one of its side edges. The grater module or grater modules can be pivoted into the accommodating space for storage purposes. The grating surface element of the respective grater module is then covered, and so the cutting edges of the grating surface element do not cause any damage during storage, e.g. in a drawer, but are in turn not damaged by other metal objects.

The ergonomic advantages are given even in the case of a fan-shaped grater according to the invention having only one grater module. However, the invention has particular advantages when a plurality of grater modules are provided. By pivoting out at least two grater modules from the basic module, support in the manner of a tripod can be achieved, and this increases the stable positioning of the fan-shaped grater on the support even further. Furthermore, when the grater is equipped appropriately, grating surface elements with different degrees of fineness are available simultaneously. The user can simply pull out the grater module having the desired form of grating surface and then push it back again or selected a different one.

Similarly, he can fan out a plurality of the grater modules at the outset and then work around the set-up multi-limb fan-shaped grater in an arcuate movement with the article to be cut, sometimes at a fine grating surface and sometimes at a coarse one.

For cleaning purposes, it is furthermore advantageous when the basic element and the grater modules are connected releasably to one another. This is first possible in that the connection is itself releasable via the pivot-axis element, which can be dismantled or removed for example via bayonet or latching connections. If the pivot-axis element is taken out, there is no longer a connection between the basic element and the grater modules, and so all the elements can be removed completely and cleaned. The individual grater modules can even be used individually like a conventional foodstuff grater, even if the advantage of the ergonomic working method on a self-supporting grater according to the invention is then abandoned.

It is furthermore advantageous to form the grater modules in two parts, specifically in each case with a head piece, which is connected to the basic element via the pivot axis, and a grating surface element, which can be latched to the associated head piece. It is thus possible to remove individual grating surface elements without having to break up the unit of basic element and grater modules as a whole.

It is further advantageous to integrally form a lateral gripping tab on at least one grater module, in order to make it possible to grip the desired grater module easily, specifically in the case of elements lying close together.

In order to increase the stability of the grating surface, which is usually made of thin stainless-steel sheet, it is advantageous when the grating surface element is intrinsically curved, in particular is arc-shaped.

The invention is explained in more detail below with reference to the drawings. In the figures:

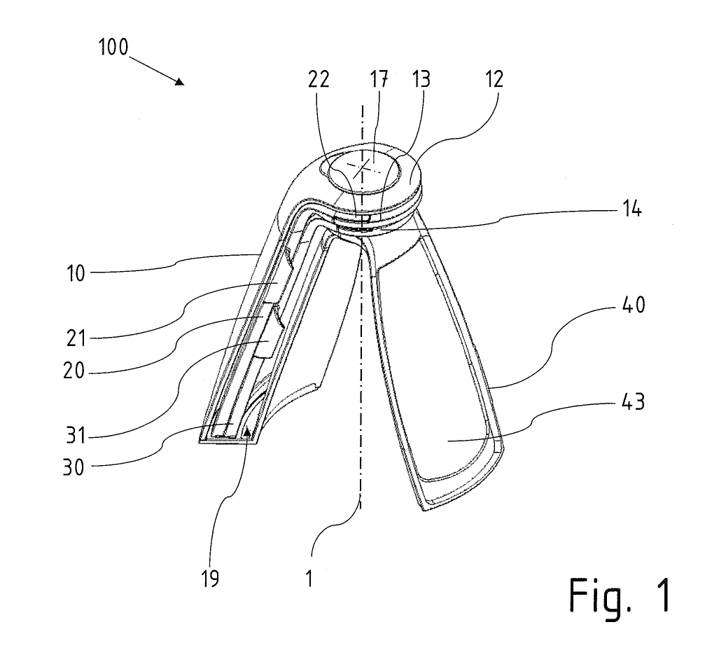

FIG. 1 shows a perspective view of a fanned-out fan-shaped grater;

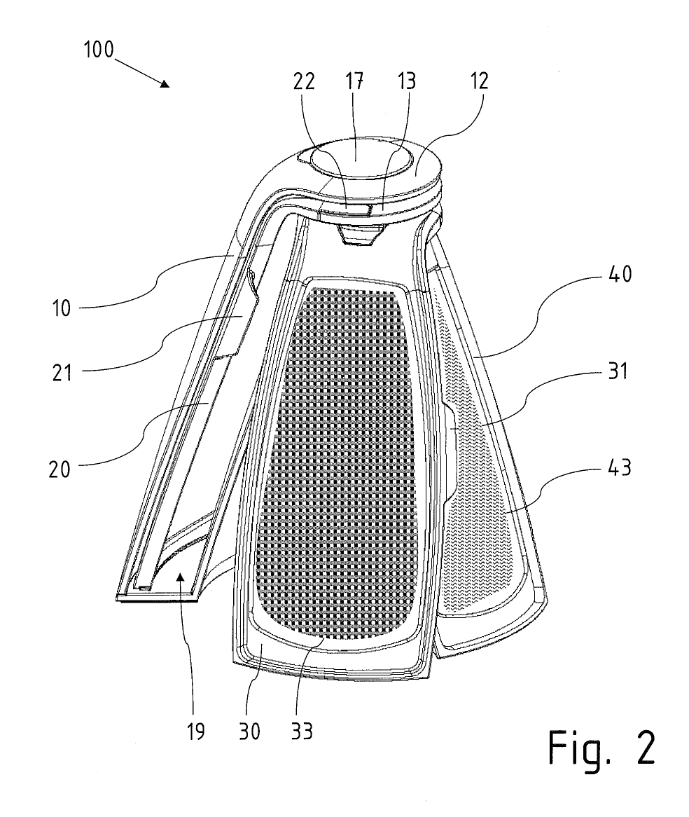

FIG. 2 shows a perspective view of a multiply fanned-out fan-shaped grater;

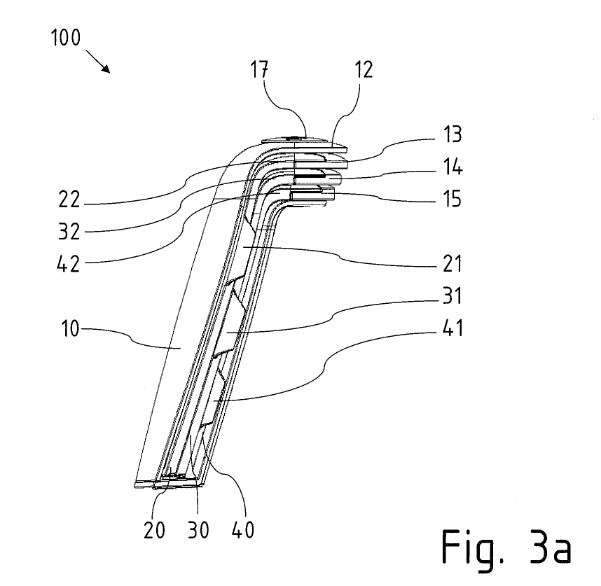

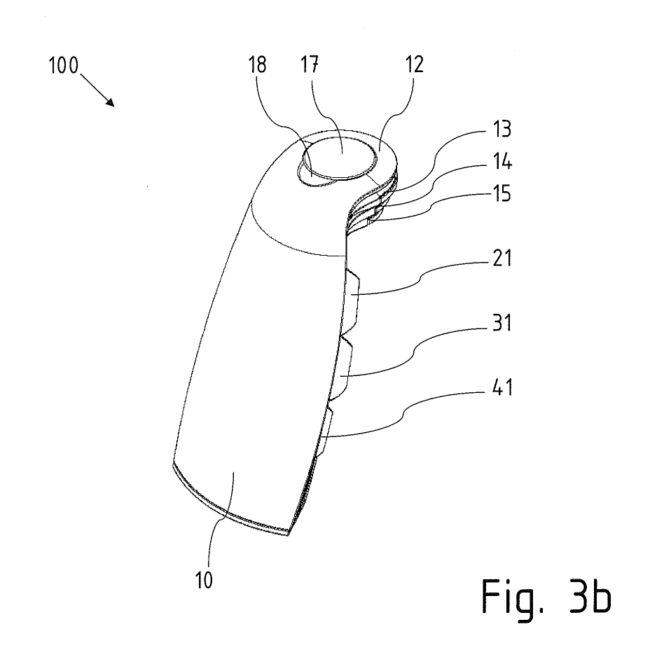

FIG. 3a shows a side view of a fan-shaped grater in the storage position and

FIG. 3b shows the same in a perspective view from the outside;

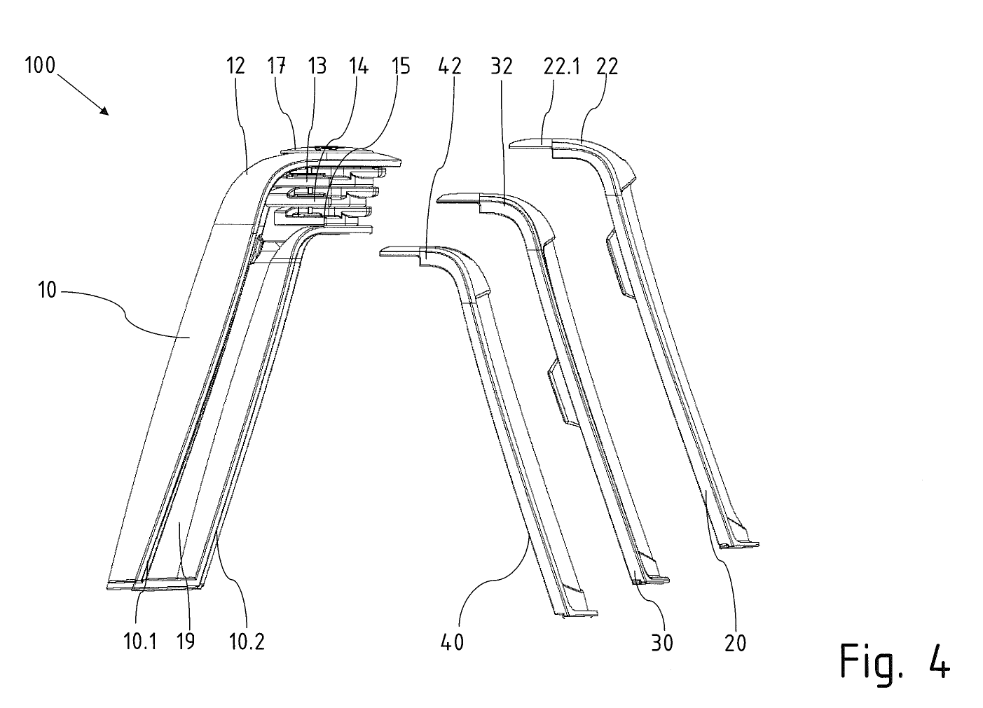

FIG. 4 shows a side view of a fanned-out fan-shaped grater;

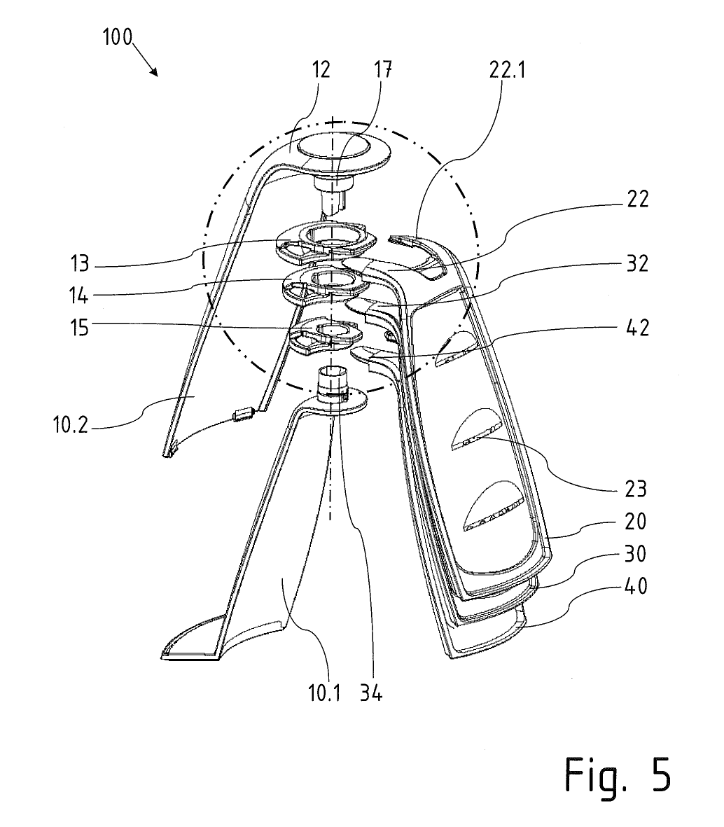

FIG. 5 shows an exploded view of a fan-shaped grater; and

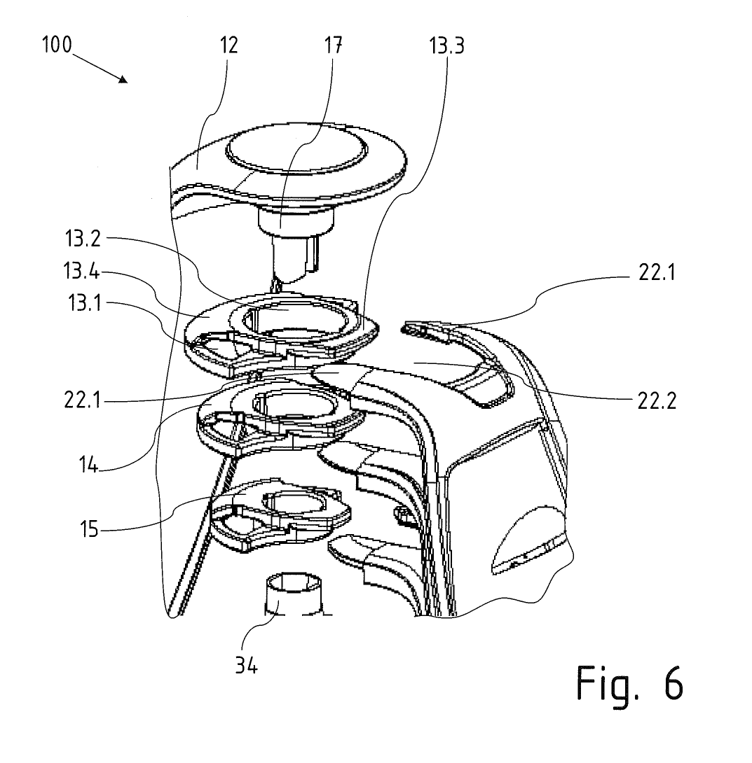

FIG. 6 shows an enlarged illustration of the detail marked in FIG. 5.

FIG. 1 shows a fan-shaped grater 100 having an outer basic element 10, which has a bent form in its upper region and merges into a head region 12.

Formed in a head region 22 of a first grater module 20 is a specially formed head piece 13, which has an accommodating clearance that cannot be seen in the exemplary embodiment illustrated, such that a pivot-axis element 17 can be inserted there. This allows a pivoting movement about a pivot axis 1.

Located thereunder is a further head piece 14 for a second grater module 30. A third grater module 40 is pivoted out and is located opposite the basic element 10, the result of which is a parabolic configuration and the fan-shaped grater stands freely. The grater modules 20 and 30 remain in an accommodating space 19 in the hollow basic element 10 and can be pulled out of the latter by means of their gripping tabs 21, 31. In the stored state, the grater modules 20, 30, 40 are thus positioned in a stacked manner one over another, wherein an outer wall 10.2 of the basic element 10 lies in the outermost position and the inner wall 10.1 thereof lies in the innermost position.

FIG. 2 shows a similar illustration of the fan-shaped grater 100, wherein the second grater module 30 has additionally be pivoted out of the accommodating space 19. Thus, two grating surface 33, 43 are now available, as a result of which a plurality of grater utensils of different forms are available to the user, namely, for example, a fine grating surface element 43 and a coarse grating surface element 33. The triple support provides a particularly stable support.

In FIGS. 3a and 3b, all the grater modules 20, 30, 40 have been pushed back into the accommodating space 19. The stacked arrangement thereof can be seen in particular from the side view in FIG. 3a. It can furthermore be seen that each of the grater modules merges into a bent head region 22, 32 or 42, said head regions being connected via the head pieces 13, 14, 15 mounted on the pivot-axis element 17.

FIG. 3b shows the same configuration in a perspective view from the outside. Of the grater modules, only the gripping tabs 21, 31, 41 protrude, and so the fan-shaped grater 100 can be stored in a space-saving manner. Also visible is a hollow 18, which allows the latched-in pivot-axis element 17 to be levered out.

FIG. 4 shows a state in which all the grater modules 20, 30, 40 have been removed from the basic element 10.

This also makes the connection to the basic element 10 clearer: the head pieces 13, 14, 15 of the grater modules 20, 30, 40 remain firmly connected to the head piece 12 of the basic element 10 by means of the pivot-axis element 17. Latching elements on the grater modules 20, 30, 40 engage therein, and so all the grater modules 20, 30, 40 can be removed, as illustrated in FIG. 4, but also each grater module individually.

The grater modules 20, 30, 40 are connected in particular by a V-shaped form with two spread-out tongues 22.1 that are pushed through clearances in the head pieces, as will be explained in more detail with reference to FIGS. 5 and 6.

FIG. 5 is an exploded illustration of the fan-shaped grater 100. All the grater modules 20, 30, 40 lie in a shell-like manner one over another. The grating surface element 23 of the outermost grater module 20 is provided here with large cutting edges, for example in order to cut cucumber slices.

In the illustration according to FIG. 5, the basic element 10 has been dismantled into its inner wall 10.1 and outer wall 10.2. Extending upwardly in the head region of the inner wall 10.1 is a pin 34 that forms a counterpart to the pivot-axis element 17 at the top and serves to mount the head pieces 14, 15 in the lower region. The three head pieces 13, 14, 15 are mounted in a pivotable manner by the pivot-axis element 17 and the associated pin 34.

The construction and connection are explained using the example of the upper head piece 13 with the associated grater module 20. The other head pieces 14, 15 and grater modules 30, 40 are similar. They are in principle formed identically, but have smaller dimensions in order to allow the shell-like stacking of the grater modules 20, 30, 40 one over another.

As the enlarged illustration in FIG. 6 shows in particular, a central clearance 13.2 on the head piece serves to accommodate the pivot-axis element 17. Clearances 13.1 are provided on both sides thereof. The grater module 20 is inclined slightly for mounting, such that the tongues 22.1 can be inserted into the clearances 13.1. If the grater module is lowered into its used position, the tongues 22.1 come to lie under a plate 13.4 of the head piece 13. Located between the tongues 22.1 there is a clearance 22.2 which is compatible with the outer contour of a lug 13.3 on the head piece, and this form fit prevents twisting.

1. A fan-shaped grater for foodstuffs, having at least one basic element and at least one grater module,
wherein the basic element and the grater module are in each case curved, angled or bent and end in a head region,
the head regions being arranged in a manner stacked one above another,
a common pivot axis, which is aligned vertically in a use state, extends through the head regions, and
a fanned-out, parabolic configuration is formable by laterally pivoting out the grater module with respect to the basic element.

2. The fan-shaped grater as claimed in claim 1, the basic element comprising an inner wall and an outer wall spaced apart therefrom, the at least one grater module pivotable into an accommodating space (19) formed between the inner wall and the outer wall.

3. The fan-shaped grater as claimed in claim 1, the basic element being connected to a plurality of grater modules, the head regions of which being arranged in a stacked manner above and/or below the head region of the basic element.

4. The fan-shaped grater as claimed in one of claim 1, the head regions, the basic element and the grater module have in each case one accommodating clearance, through which at least one pivot-axis element extends.

5. The fan-shaped grater as claimed in claim 3, at least one grater module being divided into a grating surface element and a head piece which is connected releasably thereto, said head piece being connected pivotably to the head region of the basic element via the pivot-axis element.

6. The fan-shaped grater as claimed in claim 5, the pivot-axis element is being connected in a latchable and/or insertable manner to the head pieces of the grater module and/or to the basic element.

7. The fan-shaped grater as claimed in claim 1, the basic element and the grater module or grater modules having a curved form.

8. The fan-shaped grater as claimed in claim 1, the basic element and the grater module or grater modules overlap in each case an arc segment of a circular line around the pivot axis.

9. The fan-shaped grater as claimed in claim 1, at least one grater module having at least one gripping tab on at least one side edge.

10. A fan-shaped grater, comprising:
at least one basic element having an angled form; and
at least one grater module having an angled form and connected with the basic element;
each of the basic element and grater module having a head region at one end, the head regions of the basic element and the grater module being arranged in stacked relation about a common pivot axis extending through the head regions, the grater module and the basic element being arranged to pivot with respect to each other and being formable into a fanned-out configuration.
